(19) United States
(12) Patent Application Publication
(10) Pub. No.: US 2012/0014683 A1
(43) Pub. Date: Jan. 19, 2012

(54) CAMERA FLASH SYSTEM CONTROLLED VIA MEMS ARRAY

(75) Inventors: Sauri Gudlavalleti, Machilipatnam (IN); Manish Kothari, Cupertino, CA (US)

(73) Assignee: QUALCOMM MEMS TECHNOLOGIES, INC., San Diego, CA (US)

(21) Appl. No.: 12/836,872

(22) Filed: Jul. 15, 2010

(51) Int. Cl. G03B 15/03; G02B 26/02

(52) U.S. Cl. 396/164; 359/291

(57) ABSTRACT

A camera flash system may include a light source and an array that includes MEMS-based light-modulating devices disposed in front the light source. The camera flash system may control the array to transmit light through, or substantially prevent the transmission of light through, predetermined areas of the array. In some embodiments, the array may be controlled in response to input from a user, in response to detected ambient light conditions and/or in response to the proximity of a detected subject or other detected features. For example, the camera flash system may control the array to substantially prevent the transmission of light through an area of the array that is between the light source and the eyes of a detected subject.

### FIELD OF THE INVENTION

This application relates generally to illumination technology and more specifically to camera flash assemblies.

### BACKGROUND OF THE INVENTION

Although camera flash systems have improved in recent times, some drawbacks remain. One commonly-experienced example is the “red eye” effect when a flash photograph is taken of a person or an animal. Before the pupil of a subject's eye can react to the bright light of the flash and close, much of the light passes into the subject's eye through the pupil, reflects from the back of the eyeball and passes back out through the pupil. The camera records this reflected light, which is red because of the amount of blood in the choroid that is located behind the retina. Various hardware and software solutions have been implemented to mitigate such problems, but no solution has proven to be entirely satisfactory.

### SUMMARY

Some embodiments comprise an array that includes microelectromechanical systems (“MEMS”)-based light-modulating devices. The array may be configured to absorb and/or reflect light when in a first configuration and to transmit light when in a second position. Such devices may have a fixed optical stack on a substantially transparent substrate and a movable mechanical stack or “plate” disposed at a predetermined air gap from the fixed stack. The optical stacks are chosen such that when the movable stack is “up” or separated from the fixed stack, most light entering the substrates passes through the two stacks and air gap. When the movable stack is down, or close to the fixed stack, the combined stack allows only a negligible amount of light to pass through.

According to some embodiments, a camera flash system may include a light source and an array of such MEMS-based light-modulating devices disposed in front the light source. The camera flash system may control the MEMS-based light-modulating devices to transmit light through, or substantially prevent the transmission of light through, predetermined areas of the array. In some embodiments, the array may be controlled in response to input from a user, in response to detected ambient light conditions and/or in response to the proximity of a detected subject or other detected features. For example, the camera flash system may control the MEMS array to substantially prevent the transmission of light through an area of the array that is between the light source and the eyes of a detected subject.

The predetermined areas of the array may, for example, comprise two or more groups of contiguous MEMS-based light-modulating devices, wherein the camera flash system controls the movable stack of each MEMS device in the group to be in substantially the same position (e.g., in the “up” or “down” position). According to some such embodiments, the MEMS devices in a group may be gang-driven instead of being individually controlled. In such embodiments, the camera flash system may comprise a simple and relatively inexpensive controller for this purpose, as compared with a controller that is configured to individually control each MEMS device in the array.

In some embodiments, the movable stack may be positioned at intermediate positions between the up or down positions. When the camera flash system controls the movable stack of a MEMS device to be in an intermediate position, a portion of the light from the light source may be transmitted and a portion of the light from the light source may be absorbed and/or reflected. Other embodiments of the array may include a separate layer of material that can be made relatively more transmissive or relatively more absorptive. Accordingly, such embodiments may allow areas of an array that includes MEMS-based light-modulating devices to be only partially transmissive instead of substantially transmissive or substantially non-transmissive.

Some embodiments described herein provide an apparatus that includes a light source, an array and a control system. The array may include a plurality of microelectromechanical systems (“MEMS”) devices. The array may be configured to absorb or reflect light from the light source when the array is in a first configuration and to transmit light from the light source when the array is in a second configuration. The control system may be configured to control the light source and the array such that MEMS devices in a predetermined transmissive area of the array are in the second configuration when the light source is illuminated. The transmissive area may comprise a plurality of adjacent MEMS devices.

The control system may be configured to drive the MEMS devices in more than one predetermined transmissive area of the array to the second position when the light source is illuminated. The control system may be configured to drive the MEMS devices in the predetermined transmissive area of the array to the second position for a predetermined period of time.

The control system may be configured to control a predetermined non-transmissive area of the array to be in the first configuration when the light source is illuminated. The predetermined non-transmissive area of the array may correspond with a camera's optical axis. The predetermined non-transmissive area of the array may correspond with a position of a detected face.

The control system may be further configured to control predetermined partially transmissive areas of the array to partially transmit light from the light source. The array may comprise at least one of a suspended particle device, an electrochromic device or a liquid crystal device. The array may comprise a first layer on which the MEMS devices are disposed and a second layer on which at least one of the suspended particle device, the electrochromic device or the liquid crystal device is disposed. The first layer may be disposed between the light source and the second layer. Alternatively, the second layer may be disposed between the light source and the first layer.

A camera flash system may include the apparatus. A camera may include the camera flash system.

The control system may be configured to produce a predetermined pattern on the array. The predetermined pattern may include a transmissive area and a non-transmissive area. The predetermined pattern may include a partially transmissive area. The control system may be configured to control the size and/or the location of a predetermined pattern according to detected input. The detected input may comprise input from a user input device. The detected input may comprise a detected location of a face.

Various methods are described herein. Some such methods include the following processes: receiving image data; analyzing the image data; selecting a predetermined pattern of transmissive and non-transmissive areas of a flash system array; and controlling a light source and the flash system array to selectively illuminate a scene according to the predetermined pattern. These and other processes may be performed, at least in part, by a camera controller.

The method may further involve receiving ambient light data. The selecting and/or the controlling may be performed, at least in part, according to the ambient light data. The method may also involve receiving user input data. The selecting and/or the controlling may be performed, at least in part, according to the user input data.

The analyzing may involve determining whether the image data indicate one or more faces. The analyzing may involve determining a location of a face. The method may also involve determining a pattern size and/or a pattern position according to the location of the face.

Alternative devices are provided herein. Some such devices include a light source, an illumination control apparatus and a flash control apparatus. The illumination control apparatus may include an array of microelectromechanical systems (“MEMS”) devices. The flash control apparatus may be configured for controlling the light source and the illumination control apparatus. The flash control apparatus may be further configured to control the illumination control apparatus to form a first transmissive area and a first non-transmissive area. The first transmissive area may comprise a first plurality of adjacent MEMS devices. The first non-transmissive area may comprise a second plurality of adjacent MEMS devices.

These and other methods of the invention may be implemented by various types of devices, systems, components, software, firmware, etc. For example, some features of the invention may be implemented, at least in part, by computer programs embodied in machine-readable media. Some such computer programs may, for example, include instructions for determining which areas of the array will be substantially transmissive, which areas will be substantially non-transmissive and/or which areas will be configured for partial transmission.

### BRIEF DESCRIPTION OF THE DRAWINGS

FIGS. 1A and 1B depict a simplified version of a MEMS-based light-modulating device configured to absorb and/or reflect light when in a first position and to transmit light when in a second position.

FIG. 1C is an isometric view depicting a portion of one embodiment of an interferometric modulator array in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator array.

FIG. 3 is a diagram of movable mirror position versus applied voltage for one embodiment of an interferometric modulator such as those depicted FIG. 1C.

FIG. 4 is an illustration of a set of row and column voltages that may be used to drive an interferometric modulator array.

FIG. 5A illustrates one configuration of the 3×3 interferometric modulator array of FIG. 2.

FIG. 5B illustrates an example of a timing diagram for row and column signals that may be used to cause the configuration of FIG. 5A.

FIG. 6A is a schematic cross-section of an embodiment of an electrostatically actuatable modulator device comprising two or more conductive layers.

FIG. 6B is a plot of the transmission and reflection of the modulator device of FIG. 6A as a function of wavelength for two air gap heights.

FIG. 6C is a schematic cross-section of an embodiment comprising a modulator device and an additional device.

FIG. 7A depicts an array of MEMS-based light-modulating devices in a closed position.

FIG. 7B depicts the array of MEMS devices of FIG. 7A, some of which are in a closed position and some of which are in an open position.

FIG. 7C depicts the array of MEMS devices of FIG. 7A in another configuration.

FIG. 7D depicts another array of MEMS devices in an alternative configuration.

FIG. 8A depicts a first MEMS array in a first configuration disposed in front of light source.

FIG. 8B depicts the first MEMS array in a second configuration disposed in front of light source.

FIG. 8C depicts the first MEMS array in a third configuration disposed in front of light source.

FIG. 9A is a block diagram that depicts some components of a camera having a camera flash system controlled via a MEMS array.

FIG. 9B is a block diagram that depicts an alternative embodiment of a camera having a camera flash system controlled via a MEMS array.

FIGS. 10A and 10B are front and rear views of a camera having a camera flash system controlled via a MEMS array.

FIG. 10C is a front view of a display device having a camera flash system as described herein.

FIG. 10D is a back view of a display device having a camera flash system as described herein.

FIG. 10E is a block diagram that illustrates components of a display device such as that shown in FIGS. 10C and 10D.

FIG. 11A is a flow chart that outlines steps of some methods described herein.

FIG. 11B is a flow chart that outlines steps of alternative methods described herein.

### DETAILED DESCRIPTION

While the present invention will be described with reference to a few specific embodiments, the description and specific embodiments are merely illustrative of the invention and are not to be construed as limiting. Various modifications can be made to the described embodiments. For example, the steps of methods shown and described herein are not necessarily performed in the order indicated. It should also be understood that the methods shown and described herein may include more or fewer steps than are indicated. In some implementations, steps described herein as separate steps may be combined. Conversely, what may be described herein as a single step may be implemented as multiple steps.

Similarly, device functionality may be apportioned by grouping or dividing tasks in any convenient fashion. For example, when steps are described herein as being performed by a single device (e.g., by a single logic device), the steps may alternatively be performed by multiple devices and vice versa.

MEMS interferometric modulator devices may include a pair of reflective layers positioned at a variable and controllable distance from each other to form a resonant optical gap with at least one variable dimension. This gap may be sometimes referred to herein as an “air gap,” although gases or liquids other than air may occupy the gap in some embodiments. Some embodiments comprise an array that includes MEMS-based light-modulating devices. The array may be configured to absorb and/or reflect light when in a first configuration and to transmit light when in a second position.

According to some embodiments described herein, a camera flash system may include a light source and an array that includes such MEMS devices disposed in front the light source. The camera flash system may control the array to transmit light through, or substantially prevent the transmission of light through, predetermined areas of the array. In some embodiments, the array may be controlled in response to input from a user, in response to detected ambient light conditions and/or in response to the proximity of a detected subject or other detected features. For example, the camera flash system may control the array to substantially prevent the transmission of light through an area of the array that is between the light source and the eyes of a detected subject.

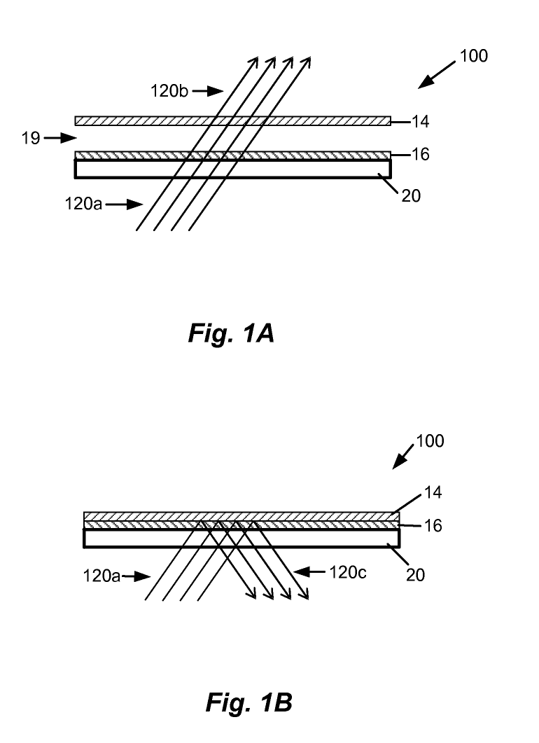

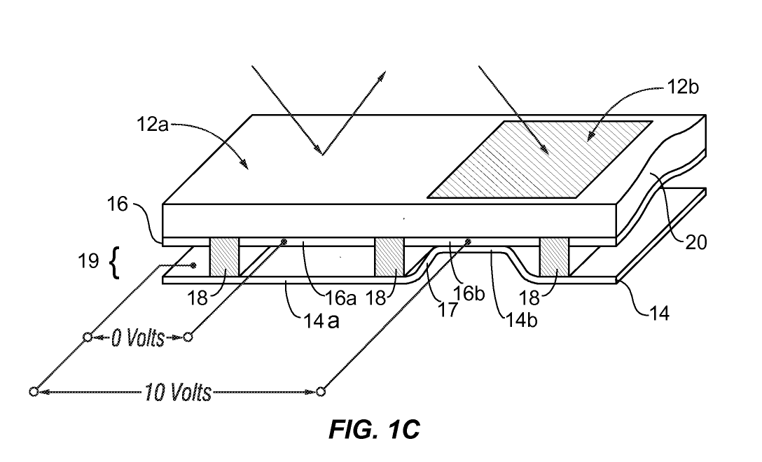

A simplified example of a MEMS-based light-modulating device that may form part of such an array is depicted in FIGS. 1A and 1B. In this example, MEMS interferometric modulator device 100 includes fixed optical stack 16 that has been formed on substantially transparent substrate 20. Movable reflective layer 14 may be disposed at a predetermined gap 19 from the fixed stack.

In some embodiments, movable reflective layer 14 may be moved between two positions. In the first position, which may be referred to herein as a relaxed position, the movable reflective layer 14 is positioned at a relatively large distance from a fixed partially reflective layer. The relaxed position is depicted in FIG. 1A. In the second position, referred to herein as the actuated position, the movable reflective layer is positioned more closely adjacent to the partially reflective layer. Alternative embodiments may be configured in a range of intermediate positions between the actuated position and the relaxed position.

The optical stacks may be chosen such that when the movable stack 14 is “up” or separated from the fixed stack 16, most visible light 120a that is incident upon substantially transparent substrate 20 passes through the two stacks and air gap. Such transmitted light 120b is depicted in FIG. 1A. However, when the movable stack 14 is down, or close to the fixed stack 16, the combined stack allows only a negligible amount of visible light to pass through. In the example depicted in FIG. 1B, most visible light 120a that is incident upon substantially transparent substrate 20 re-emerges from substantially transparent substrate 20 as reflected light 120b.

Depending on the embodiment, the light reflectance properties of the “up” and “down” states may be reversed. MEMS pixels and/or subpixels can be configured to reflect predominantly at selected colors, in addition to black and white. Moreover, in some embodiments, at least some visible light 120a that is incident upon substantially transparent substrate 20 may be absorbed. In some such embodiments, MEMS device 100 may be configured to absorb most visible light 120a that is incident upon substantially transparent substrate 20 and/or configured to partially absorb and partially transmit such light. Some such embodiments are discussed below.

FIG. 1C is an isometric view depicting two adjacent subpixels in a series of subpixels, wherein each subpixel comprises a MEMS interferometric modulator. In some embodiments, a MEMS array comprises a row/column array of such subpixels. Incident light that reflects from the two layers interferes constructively or destructively depending on the position of the movable reflective layer, producing either an overall reflective or non-reflective state for each subpixel or subpixel.

The depicted portion of the subpixel array in FIG. 1C includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

In some embodiments, the optical stacks 16a and 16b (collectively referred to as optical stack 16) may comprise several fused layers, which can include an electrode layer, such as indium tin oxide (ITO), a partially reflective layer, such as chromium, and a transparent dielectric. The optical stack 16 is thus electrically conductive, partially transparent, and partially reflective. The optical stack 16 may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row or column electrodes. For example, the movable reflective layers 14a, 14b may be formed as a series of parallel strips of a deposited metal layer or layers (which may be substantially orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a MEMS array.

With no applied voltage, the gap 19 remains between the movable reflective layer 14a and optical stack 16a, with the movable reflective layer 14a in a mechanically relaxed state, as illustrated by the subpixel 12a in FIG. 1C. However, when a potential difference is applied to a selected row and column, the capacitor formed at the intersection of the row and column electrodes at the corresponding subpixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by subpixel 12b on the right in FIG. 1C. The behavior may be the same regardless of the polarity of the applied potential difference.

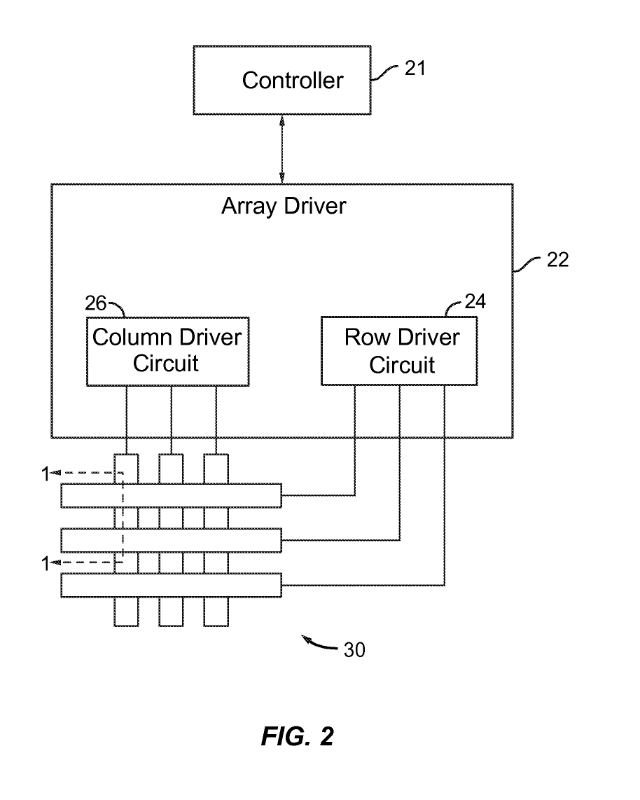

FIGS. 2 through 5B illustrate examples of processes and systems for using an array of interferometric modulators.

FIG. 2 is a system block diagram illustrating one embodiment of an electronic device that may incorporate aspects of the invention. In the exemplary embodiment, the electronic device includes a controller 21 which may comprise one or more suitable general purpose single- or multi-chip microprocessors such as an ARM, Pentium®, Pentium II®, Pentium III®, Pentium IV®, Pentium® Pro, an 8051, a MIPS®, a Power PC®, an ALPHA®, and/or any suitable special purpose logic device such as a digital signal processor, an application-specific integrated circuit (“ASIC”), a microcontroller, a programmable gate array, etc. The controller 21 may be configured to execute one or more software modules. In addition to executing an operating system, controller 21 may be configured to execute one or more software applications, such as software for executing methods described herein or any other software application.

In one embodiment, the controller 21 is also configured to communicate with an array driver 22. In one embodiment, the array driver 22 includes a row driver circuit 24 and a column driver circuit 26 that provide signals to an array or panel 30, which is a MEMS array in this example. The cross section of the MEMS array illustrated in FIG. 1C is shown by the lines 1-1 in FIG. 2.

The row/column actuation protocol may take advantage of a hysteresis property of MEMS interferometric modulators that is illustrated in FIG. 3. It may require, for example, a 10 volt potential difference to cause a movable layer to deform from the relaxed state to the actuated state. However, when the voltage is reduced from that value, the movable layer can maintain its state as the voltage drops back below 10 volts. In the example of FIG. 3, the movable layer does not relax completely until the voltage drops below 2 volts. Thus, there exists a window of applied voltage, about 3 to 7 V in the example illustrated in FIG. 3, within which the device is stable in either the relaxed or actuated state. This is referred to herein as the “hysteresis window” or “stability window.”

For a MEMS array having the hysteresis characteristics of FIG. 3, the row/column actuation protocol can be designed such that during row strobing, subpixels in the strobed row that are to be actuated are exposed to a voltage difference of about 10 volts, and subpixels that are to be relaxed are exposed to a voltage difference of close to zero volts. After the strobe, the subpixels are exposed to a steady state voltage difference of about 5 volts such that they remain in whatever state the row strobe put them in. After being driven, each subpixel sees a potential difference within the “stability window” of 3-7 volts in this example.

This feature makes the subpixel design illustrated in FIG. 1C stable under the same applied voltage conditions in either an actuated or relaxed pre-existing state. Since each subpixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the subpixel if the applied potential is fixed.

Desired areas of a MEMS array may be controlled by asserting the set of column electrodes in accordance with the desired set of actuated subpixels in the first row. A row pulse may then be applied to the row 1 electrode, actuating the subpixels corresponding to the asserted column lines. The asserted set of column electrodes is then changed to correspond to the desired set of actuated subpixels in the second row. A pulse is then applied to the row 2 electrode, actuating the appropriate subpixels in row 2 in accordance with the asserted column electrodes. The row 1 subpixels are unaffected by the row 2 pulse, and remain in the state they were set to during the row 1 pulse. This may be repeated for the entire series of rows in a sequential fashion to produce the desired configuration.

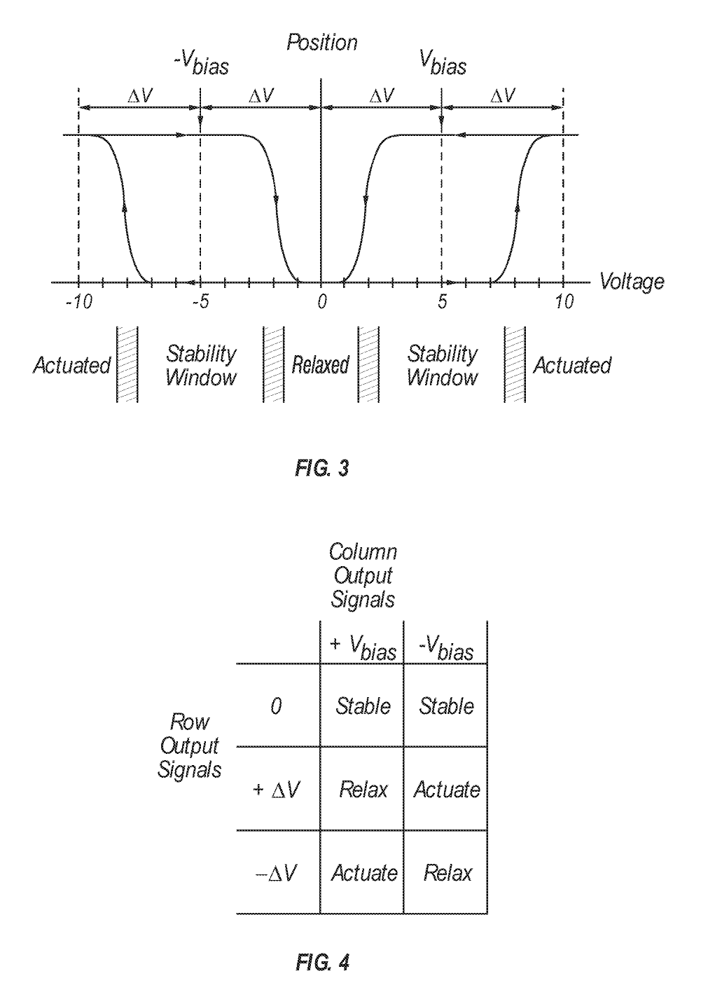

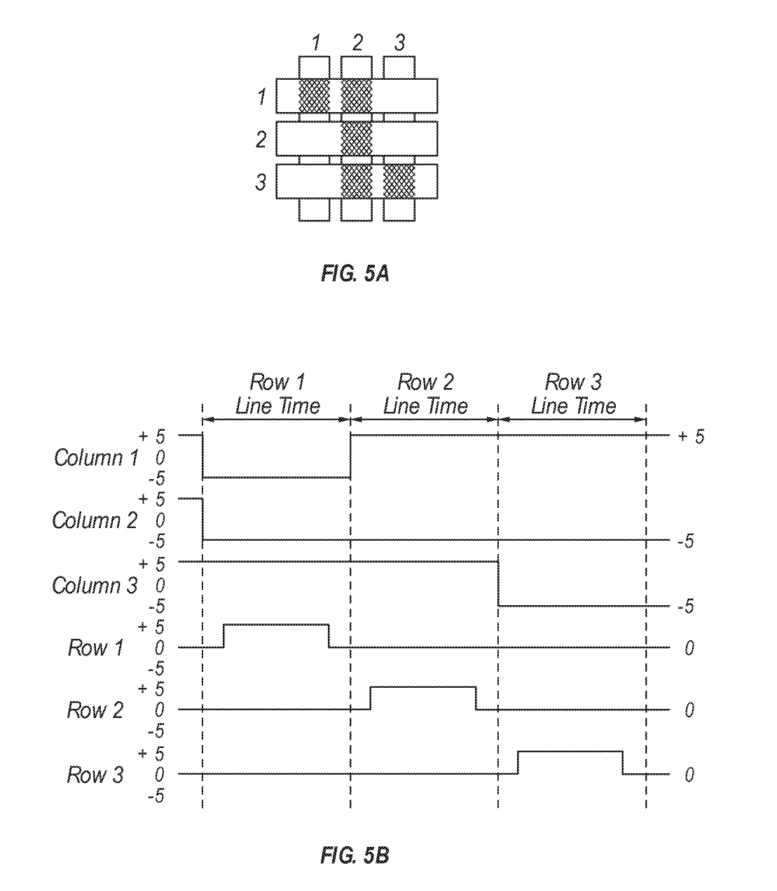

A wide variety of protocols for driving row and column electrodes of subpixel arrays may be used to control a MEMS array. FIGS. 4, 5A, and 5B illustrate one possible actuation protocol for controlling the 3×3 array of FIG. 2. FIG. 4 illustrates a possible set of column and row voltage levels that may be used for subpixels exhibiting the hysteresis curves of FIG. 3.

In the embodiment depicted in FIG. 4, actuating a subpixel involves setting the appropriate 5 column to −Vbias, and the appropriate row to +ΔV, which may correspond to −5 volts and +5 volts, respectively. Relaxing the subpixel is accomplished by setting the appropriate column to +Vbias, and the appropriate row to the same +ΔV, producing a zero volt potential difference across the subpixel. In those rows where the row voltage is held at zero volts, the subpixels are stable in whatever state they were originally in, regardless of whether the column is at +Vbias, or −Vbias. As is also illustrated in FIG. 4, it will be appreciated that voltages of opposite polarity than those described above can be used, e.g., actuating a subpixel can involve setting the appropriate column to +Vbias, and the appropriate row to −ΔV. In this embodiment, releasing the subpixel is accomplished by setting the appropriate column to −Vbias, and the appropriate row to the same −ΔV, producing a zero volt potential difference across the subpixel.

FIG. 5B is a timing diagram showing a series of row and column signals applied to the 3×3 array of FIG. 2 that will result in the arrangement illustrated in FIG. 5A, wherein actuated subpixels are non-reflective. Prior to being in the configuration illustrated in FIG. 5A, the subpixels can be in any state, and in this example, all the rows are at 0 volts, and all the columns are at +5 volts. With these applied voltages, all subpixels are stable in their existing actuated or relaxed states.

In the configuration depicted in FIG. 5A, subpixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any subpixels, because all the subpixels remain in the 3-7 volt stability window. Row 1 is then strobed with a pulse that goes from 0, up to 5 volts, and back to zero. This actuates the (1,1) and (1,2) subpixels and relaxes the (1,3) subpixel. No other subpixels in the array are affected. To set row 2 as desired, column 2 is set to −5 volts, and columns 1 and 3 are set to +5 volts. The same strobe applied to row 2 will then actuate subpixel (2,2) and relax subpixels (2,1) and (2,3). Again, no other subpixels of the array are affected. Row 3 is similarly set by setting columns 2 and 3 to −5 volts, and column 1 to +5 volts. The row 3 strobe sets the row 3 subpixels as shown in FIG. 5A. After writing the frame, the row potentials are zero, and the column potentials can remain at either +5 or −5 volts, and the array is then stable in the arrangement of FIG. 5A.

It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any suitable actuation voltage method can be used with the systems and methods described herein.

For example, in some camera-related embodiments described herein, groups of MEMS devices in predetermined areas of a MEMS array may be gang-driven instead of being individually controlled. These predetermined areas may, for example, comprise two or more groups of contiguous MEMS devices. A controller, such as a controller of a camera or of a camera flash system, may control the movable stack of each MEMS device in the group to be in substantially the same position (e.g., in the “up” or “down” position).

In some such embodiments, a camera flash system may comprise a simple and relatively inexpensive controller for this purpose, as compared with a controller that is configured to individually control each MEMS device in the array. In some embodiments, the controller may control the array in response to input from a user, in response to detected ambient light conditions and/or in response to the proximity of a detected subject or other detected features. For example, a controller of a camera flash system may control the MEMS array to substantially prevent the transmission of light through an area of the array that is between the light source and the eyes of a detected subject.

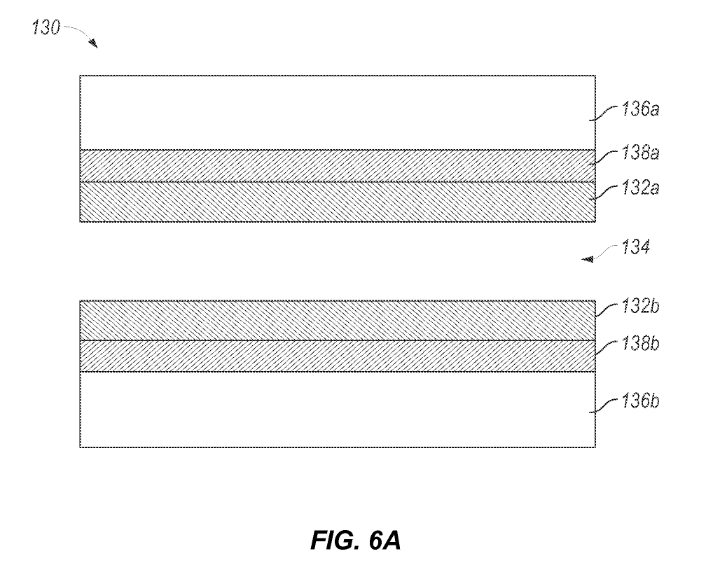

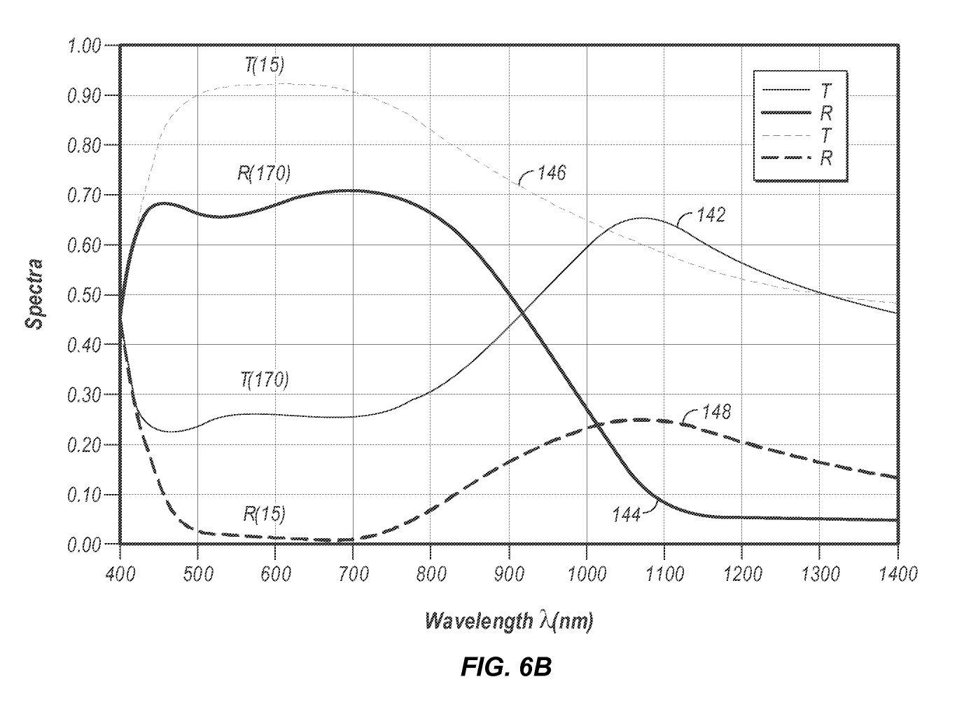

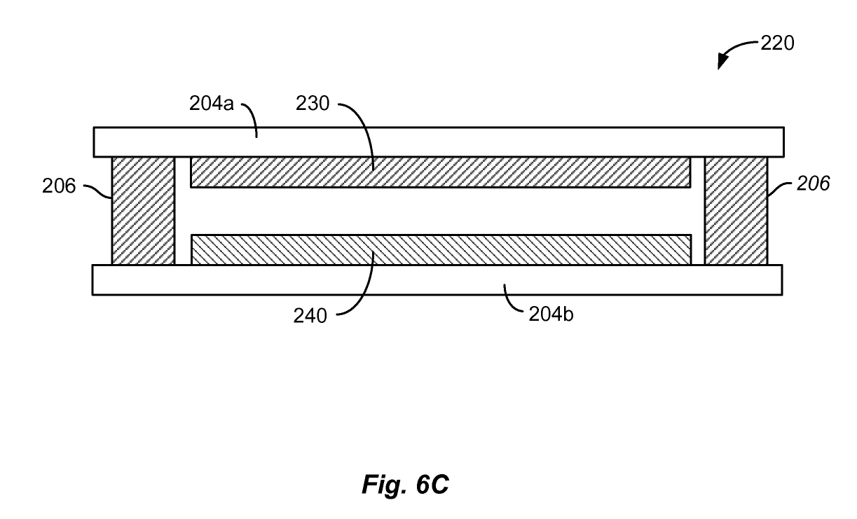

In some embodiments, a modulator device may include actuation elements integrated into the thin-film stack which permit displacement of portions of layers relative to one another so as to alter the spacing therebetween. FIG. 6A illustrates an exemplary modulator device 130 which is electrostatically actuatable. The device 130 includes a conductive layer 138a supported by a substrate 136a, and an optical layer 132a overlying the conductive layer 138a. Another conductive layer 138b is supported by substrate 136b and an optical layer 132b overlies the conductive layer 138b. The optical layer 132a and 132b are separated from one another by an air gap. Application of a voltage across conductive layers 138a and 138b will cause the one of the layers to deform towards the other one.

In some embodiments, the conductive layers 138a and 138b may comprise a transparent or light-transmissive material, such as indium tin oxide (ITO), for example, although other suitable materials may be used. The optical layers 132a and 132b may comprise a material having a high index of refraction. In some particular embodiments, the optical layers 132a and 132b may comprise titanium dioxide, although other materials may be used as well, such as lead oxide, zinc oxide, and zirconium dioxide, for example. The substrates may comprise glass, for example, and at least one of the substrates may be sufficiently thin to permit deformation of one of the layers towards the other.

In one embodiment in which the conductive layers 138a and 138b comprise ITO and are 80 nm in thickness, the optical layers 132a and 132b comprise titanium dioxide and are 40 nm in thickness, and the air gap is initially 170 nm in height. FIG. 6B illustrates plots across the visible and a portion of infrared wavelengths of the modeled transmission and reflectivity as a function of wavelength λ of the modulator device 130 both when the device is in an actuated state with an air gap of 15 nm and in an unactuated state with an air gap of 170 nm. The 15 nm air gap represents a fully actuated state, but surface roughness may in some embodiments prevent a further reduction in air gap size. In particular, line 142 illustrates the transmission as a function of wavelength when the device is in an unactuated position (T(170)), and line 144 illustrates the reflectivity in the same state (R(170)). Similarly, line 146 illustrates the transmission as a function of wavelength when the device is in an actuated position (T(15)), and line 148 illustrates the reflectivity in the actuated position (R(15)).

It can be seen from these plots that the modulator device 130 is highly transmissive across visible wavelengths when in an actuated state with a small air gap (15 nm), particularly for those wavelengths of less than about 800 nm. When in an unactuated state with a larger air gap (170 nm), the device becomes roughly 70% reflective to those same wavelengths. In contrast, the reflectivity and transmission of the higher wavelengths, such as infrared wavelengths, does not significantly change with actuation of the device. Thus, the modulator device 130 can be used to selectively alter the transmission/reflection of a wide range of visible wavelengths, without significantly altering the infrared transmission/reflection (if so desired).

FIG. 6C illustrates an embodiment of an apparatus 220, in which a first modulator device 230 is formed on a first substantially transparent substrate 204a, and a second device 240 is formed on a second substantially transparent substrate 204b. In one embodiment, the first modulator device 230 comprises a modulator device capable of switching between a state which is substantially transmissive to a wide range of visible radiation and another state in which the reflectance across a wide range of visible radiation is increased.

The second device 240 may in certain embodiments comprise a device which transmits a certain amount of incident light. In certain embodiments, the device 240 may comprise a device which absorbs a certain amount of incident light. In particular embodiments, the device 240 may be switchable between a first state which is substantially transmissive to incident light, and a second state in which the absorption of at least certain wavelengths is increased. In still other embodiment, the device 240 may comprise a fixed thin film stack having desired transmissive, reflective, or absorptive properties.

In certain embodiments, suspended particle devices (“SPDs”) may be used to change between a transmissive state and an absorptive state. These devices comprise suspended particles which in the absence of an applied electrical field are randomly positioned, so as to absorb and/or diffuse light and appear “hazy.” Upon application of an electrical field, these suspended particles may be aligned in a configuration which permits light to pass through.

Other devices 240 may have similar functionality. For example, in alternative embodiments device 240 may comprise another type of “smart glass” device, such as an electrochromic device, micro-blinds or a liquid crystal device (“LCD”). Electrochromic devices change light transmission properties in response to changes in applied voltage. Some such devices may include reflective hydrides, which change from transparent to reflective when voltage is applied. Other electrochromic devices may comprise porous nano-crystalline films. In another embodiment, device 240 may comprise an interferometric modulator device having similar functionality.

Thus, when the device 240 comprises an SPD or a device having similar functionality, the apparatus 220 can be switched between three distinct states: a transmissive state, when both devices 230 and 240 are in a transmissive state, a reflective state, when device 230 is in a reflective state, and an absorptive state, when device 240 is in an absorptive state. Depending on the orientation of the apparatus 220 relative to the incident light, the device 230 may be in a transmissive state when the apparatus 220 is in an absorptive state, and similarly, the device 240 may be in a transmissive state when the apparatus 220 is in an absorptive state.

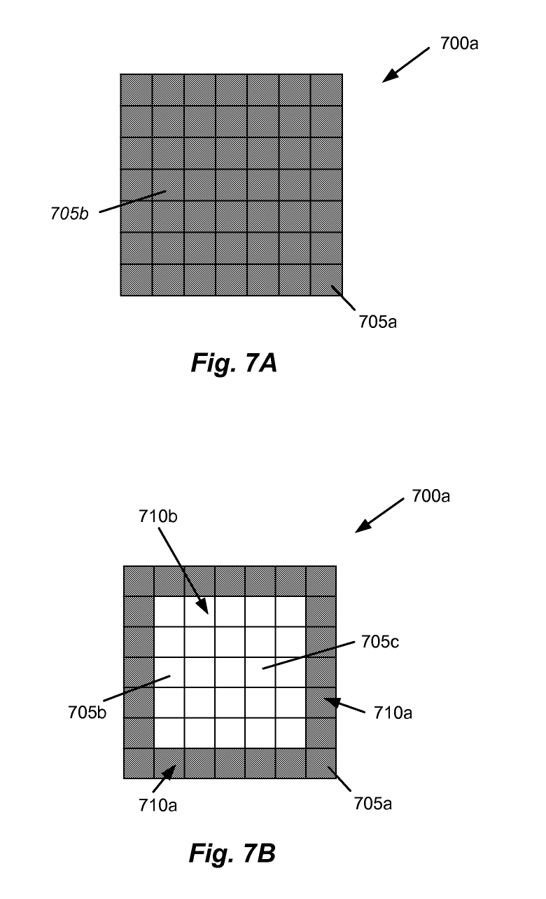

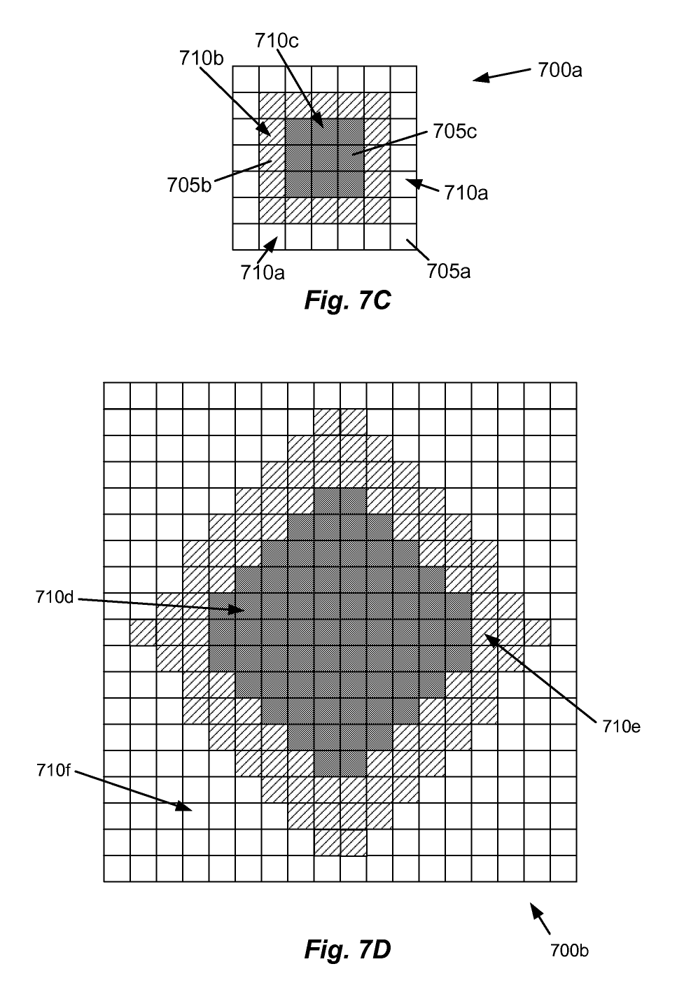

An array of MEMS devices that may be used for some embodiments described herein is depicted in FIGS. 7A-7C. Although such MEMS devices may be grouped into what may be referred to herein as a “MEMS array” or the like, some such MEMS arrays may include devices other than MEMS devices. For example, some MEMS arrays described herein may include non-MEMS devices, including but not limited to an SPD or a device having similar functionality, that is configured to selectively absorb or transmit light.

Referring first to FIG. 7A, MEMS array 700a is shown in a first configuration, in which MEMS array 700a is configured to block substantially all visible incident light. In this example, groups of individual MEMS devices of MEMS array 700a are controlled together. Here, each of cells 705 includes a plurality of individual MEMS devices (and possibly other devices, such as SPDs or devices having similar functionality), all of which are configured to be gang-driven by a controller. For example, each of the individual devices within cell 705a may be controlled as a group. Similarly, each of the individual devices within cell 705b will be controlled as a group.

Referring now to FIG. 7B, it will be observed that all of the cells within area 710a, including cell 705a, are being controlled to block substantially all visible incident light. However, all of the cells within area 710b, including cell 705b, are being controlled to transmit substantially all visible incident light. In this example, fewer than 50 individual cells need to be individually controlled. Although alternative embodiments may involve controlling more or fewer cells, controlling individual devices within each cell as a group can greatly simplify the control system required for controlling a MEMS array.

Further simplifications may be introduced in other embodiments, for example, by controlling an entire row, column or other aggregation of cells 705 as a group. In some such embodiments, all of the cells 705 within area 710a may be controlled as a group. In some such embodiments, the devices with area 710a and/or other portions of MEMS array 700a may be organized into separately controllable cells 705, but alternative embodiments may not comprise separately controllable cells 705. In some embodiments, columns and/or rows of devices and/or cells 705 may be controlled as a group.

In FIG. 7C, all of the cells within area 710a, including cell 705a, are being controlled to transmit substantially all visible incident light. Here, all of the cells within area 710c, including cell 705c, are being controlled to block substantially all visible incident light. In this example, all of the cells within area 710b, including cell 705b, are being controlled to partially transmit visible incident light. According to some such embodiments, array 700c may include an SPD, an electrochromic device or an LCD.

FIG. 7D depicts MEMS array 700b. As with MEMS array 700a, all of the cells within area 710a are being controlled to transmit substantially all visible incident light, all of the cells within area 710c are being controlled to block substantially all visible incident light and all of the cells within area 710b are being controlled to partially transmit visible incident light. However, MEMS array 700b is organized into a larger number of cells than depicted in MEMS array 700a. Some such embodiments may be incrementally more complex, but can provide advantages. For example, as the number of cells in a MEMS array increases, the shapes of the predetermined areas 710 may be made smoother and/or more complex, if so desired. With increasing numbers of cells, shapes other than squares or rectangles may be formed. Oval areas, circular areas and other areas having curved sides may be approximated.

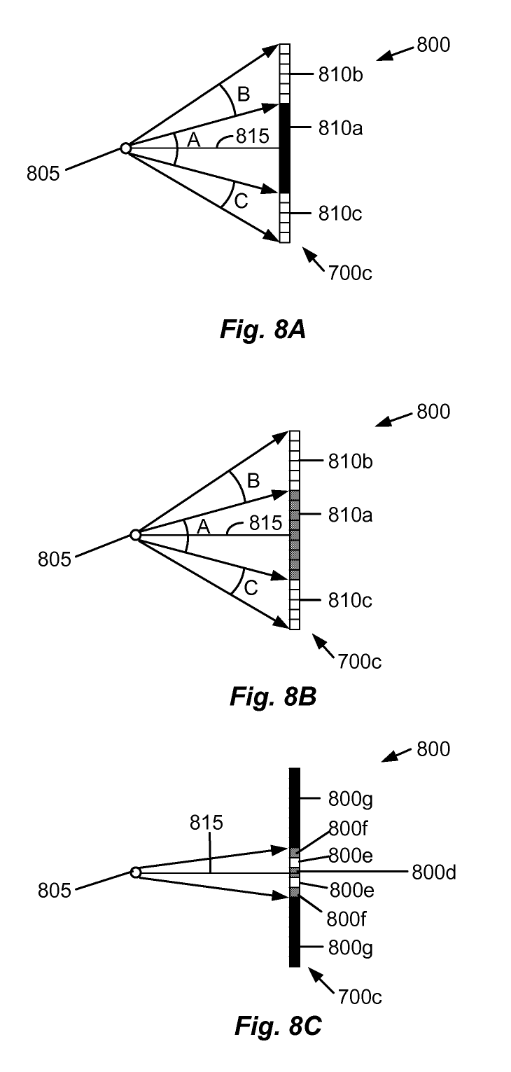

FIGS. 8A through 8C depict a simplified version of a camera flash assembly 800 in three different configurations. Camera flash assembly 800 includes light source 805 and MEMS array 700c. Light source 805 may comprise, e.g., an electronic flashtube, a light-emitting diode (“LED”) assembly, or any other appropriate light source. Camera flash assembly 800 may include one or more reflective surfaces (not shown) for directing light from light source 805 towards MEMS array 700c.

Cross-sectional views of MEMS array 700c are depicted in FIGS. 8A through 8C. In FIG. 8A, a controller of camera flash assembly 800 is controlling MEMS devices within area 810a to block substantially all incident visible light that is emitted by light source 805 within angle A. Here, angle A is bisected by imaginary optical axis 815, which passes through light source 805 and the center of array 700c. In this example, devices within area 810a of array 700c are configured to absorb a substantial amount of the visible light that is incident upon area 810a. Alternative embodiments may be configured to reflect a substantial amount of the visible light that is incident upon area 810a. Areas 810b and 810c are configured to transmit most visible light within angles B and C, respectively.

In FIG. 8B, a controller of camera flash assembly 800 is controlling devices within area 810a to partially block and partially transmit the visible light that is incident upon area 810a. The degree of light transmission may be predetermined and the devices within area 810a may be controlled according to pre-set configuration data. For example, an SPD, an electrochromic device or an LCD may be configured to partially transmit and partially absorb light from light source 805. In some embodiments, MEMS devices within area 810a may be driven to a predetermined intermediate position between the “up” and “down” positions depicted in FIGS. 1A and 1B. The predetermined intermediate position may correspond with a known overall or average percentage of transmittance for light in the visible range.

Data corresponding to predetermined levels of light transmission and/or light absorption may be stored and selectively retrieved by a controller to produce a predetermined effect. For example, data driving MEMS devices to a predetermined intermediate position may be stored in a memory accessible by a controller of the camera flash system and retrieved when the controller will drive the MEMS devices to the predetermined intermediate position.

Alternatively, non-MEMS devices within area 810a may be configured to absorb and/or transmit a predetermined percentage of the incident visible light. For example, data for controlling an SPD, an electrochromic device or an LDC to transmit and/or absorb a predetermined percentage of the incident visible light may be stored and selectively retrieved by a controller for controlling the array. In some such implementations, MEMS devices within area 810a may be driven to a position corresponding with maximum transmittance and the degree of transmission or absorption may be controlled by the non-MEMS device(s). The MEMS devices and non-MEMS devices may, for example, be disposed in different layers of MEMS array 700c, e.g., as depicted in FIG. 6C. Areas 810b and 810c are once again configured to transmit most visible light within angles B and C, respectively.

In FIG. 8C, array 700c is configured to block substantially all of the light that is incident upon areas 800g. In this example, areas 800e, 800f and 800g are contiguous within the plane of array 700c, like areas 710d, 710e and 710f of FIG. 7D. Here, devices within areas 800d and 800f of array 700c are configured to partially block and partially transmit the visible light that is incident upon these areas, whereas areas 800e are configured to transmit a substantial amount of the visible light that is incident upon those areas.

In some embodiments, a controller may configure an array to produce one or more predetermined patterns of transmissive, non-transmissive and/or partially transmissive areas. The predetermined patterns may be configured according to parameters stored in a local memory and/or stored algorithms for creating the patterns. Some such patterns may be similar to those illustrated herein, whereas other patterns may be different. For example, whereas the patterns illustrated herein are generally depicted as being symmetrical, alternative patterns may not be symmetrical.

Moreover, the center of a pattern may not correspond with the center of an array. For example, the center of a pattern may be selected to correspond with an area to which light should be selectively transmitted or from which light should selectively be blocked. Such areas may or may not be near the center of the array. In some instances, the center of a pattern may be selected to correspond with an area corresponding with a detected face. Multiple patterns may be used, e.g., to block light from a flash from being directly transmitted towards multiple detected faces in an image.

In some embodiments, predetermined patterns may be reduced in size or enlarged in response to detected inputs or detected conditions. For example, a pattern such as that illustrated in FIG. 7C or FIG. 7D may be reduced in size in order to selectively block light from being transmitted a smaller portion of a detected image. Enlarging or reducing the size of a pattern may be desirable, for example, in response to whether a detected face occupies relatively more or relatively less of a detected image.

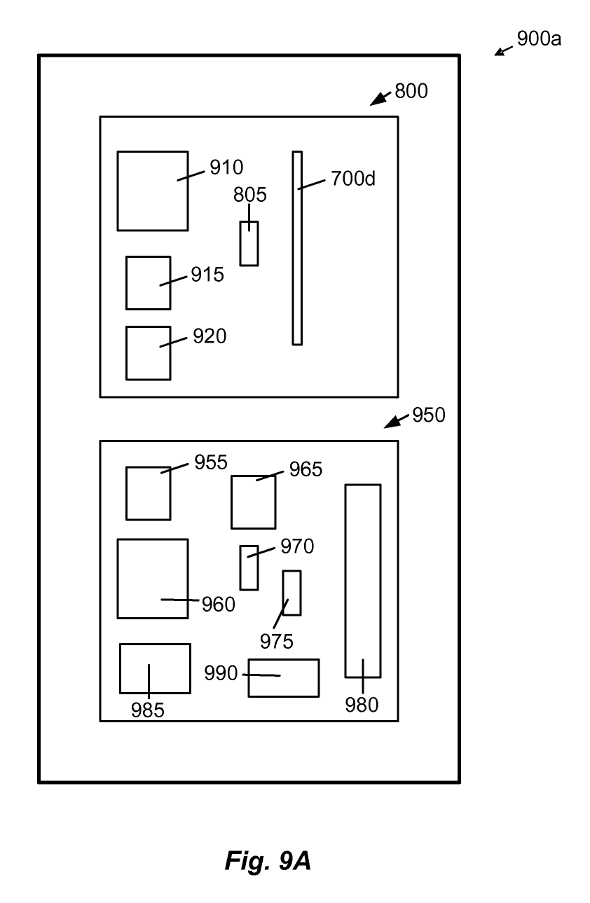

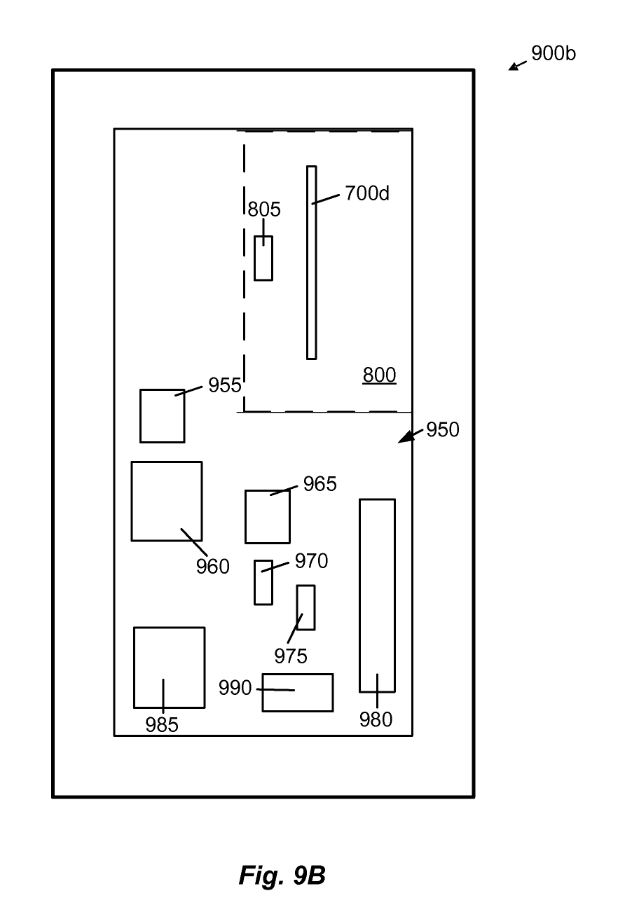

FIG. 9A is a block diagram that depicts components of a camera 900a according to some embodiments described herein. Camera flash assembly 800 includes light source 805 and MEMS array 700d. Camera flash assembly 800 also includes flash assembly controller 910, which is configured for controlling light source 805 and MEMS array 700d. Flash assembly controller 910 may include one or more general purpose or special purpose processors, logic devices, etc. In some embodiments, flash assembly controller 910 may be configured to control light source 805 and/or MEMS array 700d to implement, at least in part, methods described herein. For example, flash assembly controller 910 may be configured to control light source 805 and MEMS array 700d according to firmware and/or software stored on a tangible medium, such as memory 915. In some implementations, flash assembly controller 910 may have its own memory.

In some embodiments, flash assembly controller 910 may be configured to control light source 805 and/or MEMS array 700d according to instructions received via flash interface system 920. Here, flash interface system 920 includes an input/output (“I/O”) system configured to enable communication with flash assembly controller 910. Moreover, flash interface system 920 may include the necessary physical interface(s), including but not limited to electrical interface(s), necessary for coupling camera flash assembly 800 with camera 900a. Here, flash interface system 920 is configured to be coupled with a corresponding portion of camera interface system 955.

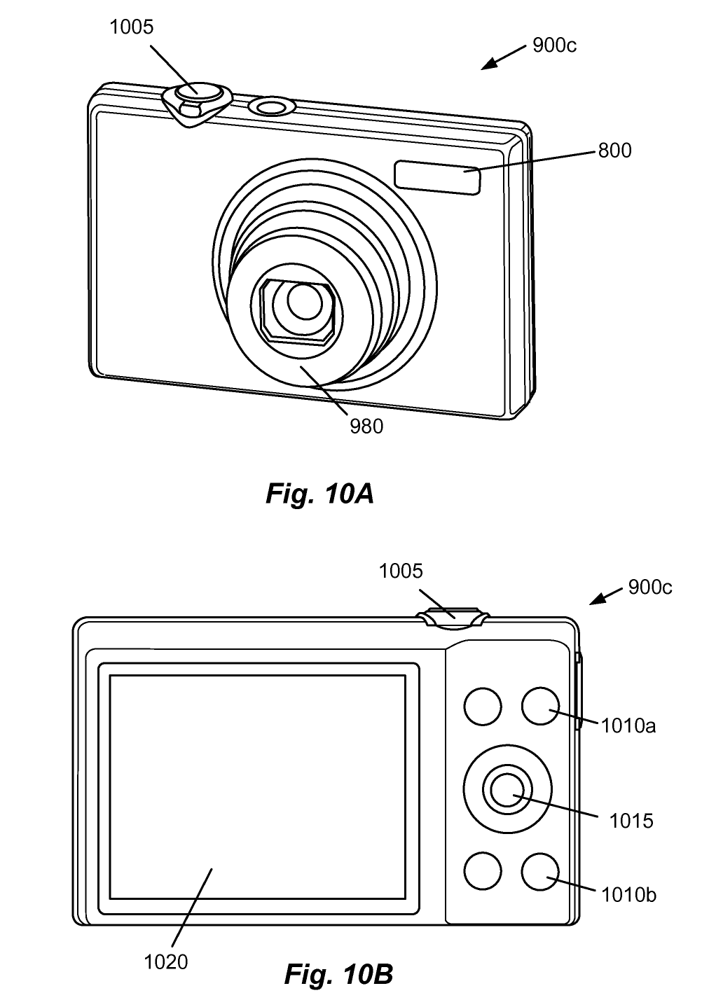

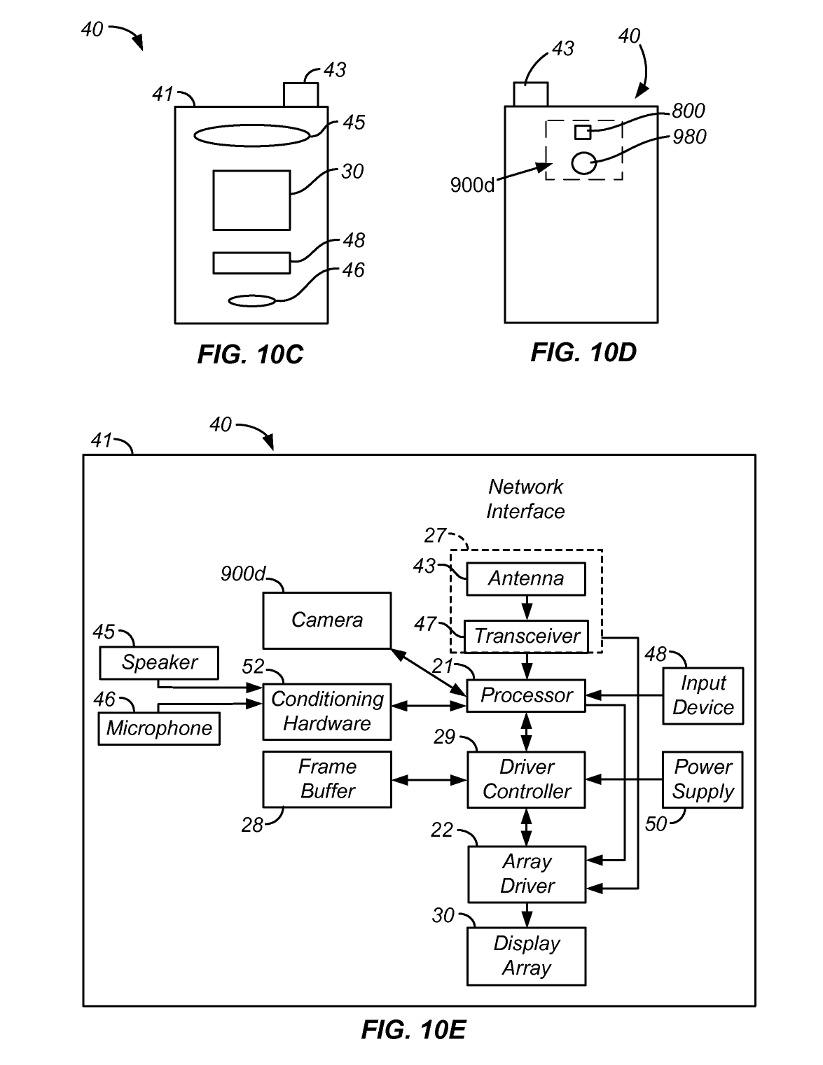

In this example, camera assembly 950 provides at least some input to flash assembly controller 910 via camera interface system 955 and flash interface system 920. Here, camera assembly 950 includes ambient light sensor 975: camera assembly 950 provides ambient light data to flash assembly controller 910. In alternative embodiments, flash assembly controller 910 may include some type of ambient light sensor. Camera assembly 950 also includes user interface system 965. Some examples of user interface components are depicted in FIGS. 10A and 10B.

Camera assembly 950 includes camera controller 960, which may include one or more general purpose or special purpose processors, logic devices, etc. Camera controller 960 is configured to control lens system 980. As such, camera controller 960 controls the focal length, autofocus functionality, etc., of lens system 980. In this example, lens system 980 includes the lens(es), shutter system and aperture control system of camera assembly 950. (In alternative implementations, camera assembly 950 may have a separate lens system, shutter system and aperture control system.) Camera controller 960 is configured to control the aperture size, shutter speed, shutter timing, etc. Such control may be made, at least in part, according to input from the user interface system 965 and light sensor 975.

FIGS. 10C-10E are system block diagrams illustrating an embodiment of a display device 40 that includes a camera having a camera flash assembly as provided herein. The display device 40 may be, for example, a portable device such as a cellular or mobile telephone, a personal digital assistant (“PDA”), etc. However, the same components of display device 40 or slight variations thereof are also illustrative of various types of display devices such as portable media players.

Referring now to FIG. 10C, a front side of display device 40 is shown. This example of display device 40 includes a housing 41, a display 30, an antenna 43, a speaker 45, an input system 48, and a microphone 46. The housing 41 is generally formed from any of a variety of manufacturing processes as are well known to those of skill in the art, including injection molding and vacuum forming. In addition, the housing 41 may be made from any of a variety of materials, including, but not limited to, plastic, metal, glass, rubber, and ceramic, or a combination thereof. In one embodiment, the housing 41 includes removable portions (not shown) that may be interchanged with other removable portions of different color, or containing different logos, pictures, or symbols.

The display 30 in this example of the display device 40 may be any of a variety of displays. Moreover, although only one display 30 is illustrated in FIG. 10C, display device 40 may include more than one display 30. For example, the display 30 may comprise a flat-panel display, such as plasma, an electroluminescent (EL) display, a light-emitting diode (LED) (e.g., organic light-emitting diode (OLED)), a transmissive display such as a liquid crystal display (LCD), a bi-stable display, etc. Alternatively, display 30 may comprise a non-flat-panel display, such as a cathode ray tube (CRT) or other tube device, as is well known to those of skill in the art. However, for the embodiments of primary interest in this application, the display 30 includes at least one transmissive display.

FIG. 10D illustrates a rear side of display device 40. In this example, camera 900d is disposed on an upper portion of the rear side of display device 40. Here, camera flash assembly 800 is disposed above lens system 980.

The components of one embodiment in this example of display device 40 are schematically illustrated in FIG. 2. The illustrated display device 40 includes a housing 41 and can include additional components at least partially enclosed therein. For example, in one embodiment, the display device 40 includes a network interface 27 that includes an antenna 43, which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input system 48 and a driver controller 29. The driver controller 29 is coupled to a frame buffer 28 and to an array driver 22, which in turn is coupled to a display array 30. A power supply 50 provides power to all components as required by the particular display device 40 design.

The network interface 27 includes the antenna 43 and the transceiver 47 so that the display device 40 can communicate with one or more devices over a network. In some embodiments, the network interface 27 may also have some processing capabilities to relieve requirements of the processor 21. The antenna 43 may be any antenna known to those of skill in the art for transmitting and receiving signals. In one embodiment, the antenna is configured to transmit and receive RF signals according to an Institute of Electrical and Electronics Engineers (IEEE) 802.11 standard, e.g., IEEE 802.11(a), (b), or (g). In another embodiment, the antenna is configured to transmit and receive RF signals according to the BLUETOOTH standard. In the case of a cellular telephone, the antenna may be designed to receive Code Division Multiple Access (“CDMA”), Global System for Mobile communications (“GSM”), Advanced Mobile Phone System (“AMPS”) or other known signals that are used to communicate within a wireless cell phone network. The transceiver 47 may pre-process the signals received from the antenna 43 so that the signals may be received by, and further manipulated by, the processor 21. The transceiver 47 may also process signals received from the processor 21 so that the signals may be transmitted from the display device 40 via the antenna 43.

In an alternative embodiment, the transceiver 47 may be replaced by a receiver and/or a transmitter. In yet another alternative embodiment, network interface 27 may be replaced by an image source, which may store and/or generate image data to be sent to the processor 21. For example, the image source may be a digital video disk (DVD) or a hard disk drive that contains image data, or a software module that generates image data. Such an image source, transceiver 47, a transmitter and/or a receiver may be referred to as an “image source module” or the like.

Processor 21 may be configured to control the overall operation of the display device 40. The processor 21 may receive data, such as compressed image data from the network interface 27, from camera 900d or from another image source, and process the data into raw image data or into a format that is readily processed into raw image data. The processor 21 may then send the processed data to the driver controller 29 or to frame buffer 28 (or another memory device) for storage.

Processor 21 may control camera 900d according to input received from input device 48. When camera 900d is operational, images received and/or captured by lens system 980 may be displayed on display 30. Processor 21 may also display stored images on display 30.

In one embodiment, the processor 21 may include a microcontroller, central processing unit (“CPU”), or logic unit to control operation of the display device 40. Conditioning hardware 52 may include amplifiers and filters for transmitting signals to the speaker 45, and for receiving signals from the microphone 46. Conditioning hardware 52 may be discrete components within the display device 40, or may be incorporated within the processor 21 or other components. Processor 21, driver controller 29, conditioning hardware 52 and other components that may be involved with data processing may sometimes be referred to herein as parts of a “logic system,” a “control system” or the like.

The driver controller 29 may be configured to take the raw image data generated by the processor 21 directly from the processor 21 and/or from the frame buffer 28 and reformat the raw image data appropriately for high speed transmission to the array driver 22. Specifically, the driver controller 29 may be configured to reformat the raw image data into a data flow having a raster-like format, such that it has a time order suitable for scanning across the display array 30. Then the driver controller 29 may send the formatted information to the array driver 22. Although a driver controller 29, such as a LCD controller, is often associated with the system processor 21 as a stand-alone integrated circuit (“IC”), such controllers may be implemented in many ways. For example, they may be embedded in the processor 21 as hardware, embedded in the processor 21 as software, or fully integrated in hardware with the array driver 22. An array driver 22 that is implemented in some type of circuit may be referred to herein as a “driver circuit” or the like.

The array driver 22 may be configured to receive the formatted information from the driver controller 29 and reformat the video data into a parallel set of waveforms that are applied many times per second to the plurality of leads coming from the display's x-y matrix of pixels. These leads may number in the hundreds, the thousands or more, according to the embodiment.

In some embodiments, the driver controller 29, array driver 22, and display array 30 may be appropriate for any of the types of displays described herein. For example, in one embodiment, driver controller 29 may be a transmissive display controller, such as an LCD display controller. Alternatively, driver controller 29 may be a bi-stable display controller (e.g., an interferometric modulator controller). In another embodiment, array driver 22 may be a transmissive display driver or a bi-stable display driver (e.g., an interferometric modulator display driver). In some embodiments, a driver controller 29 may be integrated with the array driver 22. Such embodiments may be appropriate for highly integrated systems such as cellular phones, watches, and other devices having small area displays. In yet another embodiment, display array 30 may comprise a display array such as a bi-stable display array (e.g., a display including an array of interferometric modulators).

The input system 48 allows a user to control the operation of the display device 40. In some embodiments, input system 48 includes a keypad, such as a QWERTY keyboard or a telephone keypad, a button, a switch, a touch-sensitive screen, or a pressure- or heat-sensitive membrane. In one embodiment, the microphone 46 may comprise at least part of an input system for the display device 40. When the microphone 46 is used to input data to the device, voice commands may be provided by a user for controlling operations of the display device 40.

Power supply 50 can include a variety of energy storage devices. For example, in some embodiments, power supply 50 may comprise a rechargeable battery, such as a nickel-cadmium battery or a lithium ion battery. In another embodiment, power supply 50 may comprise a renewable energy source, a capacitor, or a solar cell such as a plastic solar cell or solar-cell paint. In some embodiments, power supply 50 may be configured to receive power from a wall outlet.

In some embodiments, control programmability resides, as described above, in a driver controller which can be located in several places in the electronic display system. In some embodiments, control programmability resides in the array driver 22.

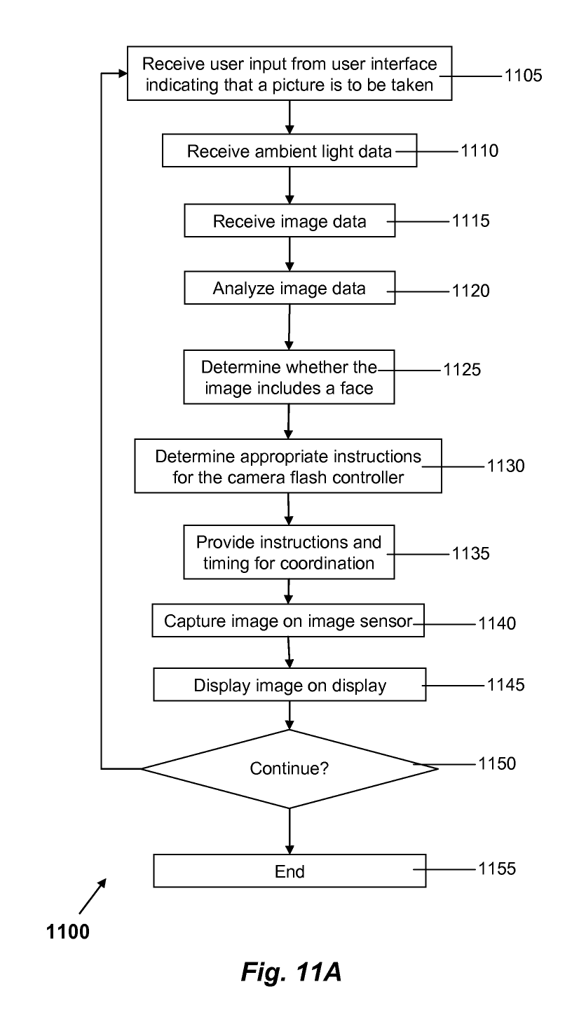

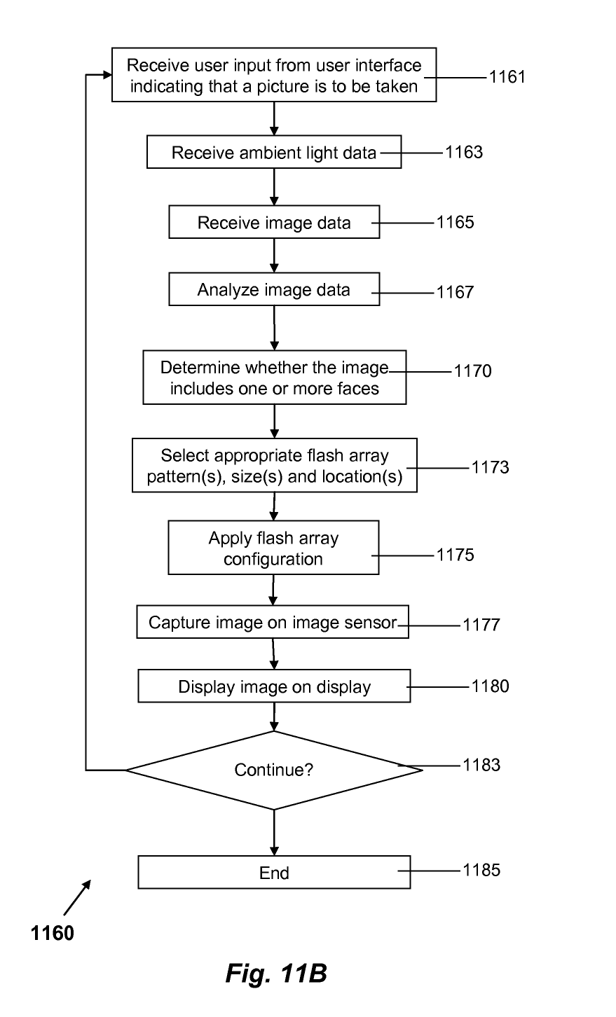

FIG. 11A is a flow chart that outlines steps of method 1100. Such a method may be performed, at least in part, by a controller such as camera controller 960 of FIG. 9A or by processor 21 of display device 40 (see FIGS. 10C-10E). The steps of method 1100, like the steps of other methods provided herein, are not necessarily performed in the order indicated. Moreover, method 1100 may include more or fewer steps than are indicated. In some implementations, steps described herein as separate steps may be combined. Conversely, what may be described herein as a single step may be implemented as multiple steps.

In step 1105, an indication is received from a user input device that a user wants to take a picture. For example, an indication may be received from shutter control 1005 of FIG. 10A that a user has depressed the shutter control. Ambient light data are received from ambient light sensor 975 of FIG. 9A in this example. (Step 1110.) In step 1115, image data are received via lens assembly 980 and image sensor 970. Camera controller 960 analyzes these image data (step 1120) and determines whether the image includes one or more faces. (Step 1125.)

According to the received ambient light data, the results of the face detection process, etc., camera controller 960 determines appropriate instructions for flash assembly controller 910. (Step 1130.) In this example, camera controller 960 also determines appropriate shutter and aperture configurations. However, in alternative implementations, the shutter and/or aperture configuration may be controlled according to input received via user interface system 965. In this example, camera controller 960 provides instructions regarding an appropriate configuration of MEMS device 700d and the appropriate timing, intensity and duration of the flash(es) from light source 805. (Step 1135.)

Camera controller 960 controls lens system 980 to capture the image on image sensor 970 at the appropriate time. (Step 1140.) The image is displayed on display device 1020. (Step 1145.) The image may be deleted, edited, stored or otherwise processed according to input received from user input system 965. In step 1150, it will be determined whether the process will continue. For example, it may be determined whether input has been received from the user within a predetermined time, whether the user is powering off the camera, etc. In step 1155, the process ends.

FIG. 11B is a flow chart that outlines steps of method 1160. Such a method may be performed, at least in part, a controller such as camera controller 960 of FIG. 9B. Steps 1161 through 1170 may be performed in a manner similar to that of steps 1105 through 1125 of method 1100. Therefore, these steps will not be described again here. However, some embodiments of method 1160 may be simpler to implement that some embodiments of method 1100, because a single processor is controlling the various components of a camera.

In step 1173, camera controller 960 selects one or more predetermined array patterns, sizes and locations. The selection of step 1173 may be made, as least in part, as to whether camera controller 960 has determined that the image includes one or more faces, how much of the image the faces occupy and how many faces have been detected. The patterns may or may not be allowed to overlap, according to the implementation. In this example, patterns are allowed to overlap.

In step 1175, camera controller 960 directly applies the selected flash array patterns, sizes and locations to the array, which is array 700d of FIG. 9B in this example. Camera controller 960 controls lens assembly 980, light source 805 and image sensor 970 to capture an image on image sensor 970. (Step 1177.) The image is displayed on display device 1020. (Step 1180.) The image may be deleted, edited, stored or otherwise processed, e.g., according to input received from user input system 965. In step 1183, it will be determined whether the process will continue. In step 1185, the process ends.

Although illustrative embodiments and applications are shown and described herein, many variations and modifications are possible which remain within the concept, scope, and spirit of what has been provided herein, and these variations should become clear after perusal of this application. For example, alternative MEMS devices and/or fabrication methods such as those described in U.S. application Ser. No. 12/255,423, entitled “Adjustably Transmissive MEMS-Based Devices” and filed on Oct. 21, 2008 (which is hereby incorporated by reference) may be used. Accordingly, the present embodiments are to be considered as illustrative and not restrictive, and the invention is not to be limited to the details given herein, but may be modified within the scope and equivalents of the appended claims.

I claim:

1. An apparatus, comprising:
a light source;
an array that includes a plurality of micro electromechanical systems (“MEMS”) devices, the array configured to absorb or reflect light from the light source when the array is in a first configuration and to transmit light from the light source when the array is in a second configuration; and
a control system configured to control the light source and the array such that MEMS devices in a predetermined transmissive area of the array are in the second configuration when the light source is illuminated, the transmissive area comprising a plurality of adjacent MEMS devices.

2. The apparatus of claim 1, wherein the control system is configured to drive the MEMS devices in more than one predetermined transmissive area of the array to the second position when the light source is illuminated.

3. The apparatus of claim 1, wherein the control system is configured to drive the MEMS devices in the predetermined transmissive area of the array to the second position for a predetermined period of time.

4. The apparatus of claim 1, wherein the control system is configured to control a predetermined non-transmissive area of the array to be in the first configuration when the light source is illuminated.

5. The apparatus of claim 1, wherein the control system is further configured to control predetermined partially transmissive areas of the array to partially transmit light from the light source.

6. A camera flash system comprising the apparatus of claim 1.

7. The apparatus of claim 1, wherein the control system is configured to produce a predetermined pattern on the array, the predetermined pattern including a transmissive area and a non-transmissive area.

8. The apparatus of claim 4, wherein the predetermined non-transmissive area of the array corresponds with a camera's optical axis.

9. The apparatus of claim 4, wherein the predetermined non-transmissive area of the array corresponds with a position of a detected face.

10. The apparatus of claim 5, wherein the array comprises at least one of a suspended particle device, an electrochromic device or a liquid crystal device.

11. A camera comprising the camera flash system of claim 6.

12. The apparatus of claim 7, wherein the predetermined pattern includes a partially transmissive area.

13. The apparatus of claim 7, wherein the control system is configured to control at least one of the size or the location of a predetermined pattern according to detected input.

14. The apparatus of claim 10, wherein the array comprises a first layer on which the MEMS devices are disposed and a second layer on which at least one of the suspended particle device, the electrochromic device or the liquid crystal device is disposed.

15. The apparatus of claim 13, wherein the detected input comprises input from a user input device.

16. The apparatus of claim 13, wherein the detected input comprises a detected location of a face.

17. The apparatus of claim 14, wherein the first layer is disposed between the light source and the second layer.

18. The apparatus of claim 14, wherein the second layer is disposed between the light source and the first layer.

19. A method, comprising:
receiving, by a camera controller, image data;
analyzing, by the camera controller, the image data;
selecting, by the camera controller, a predetermined pattern of transmissive and non-transmissive areas of a flash system array; and
controlling a light source and the flash system array to selectively illuminate a scene according to the predetermined pattern.

20. The method of claim 19, further comprising receiving, by the camera controller, ambient light data, wherein at least one of the selecting or the controlling is performed at least in part according to the ambient light data.

21. The method of claim 19, further comprising receiving, by the camera controller, user input data, wherein at least one of the selecting or the controlling is performed at least in part according to the user input data.

22. The method of claim 19, wherein the analyzing comprises determining whether the image data indicate one or more faces.

23. The method of claim 19, wherein the analyzing comprises determining a location of a face, further comprising determining at least one of a pattern size or a pattern position according to the location of the face.

24. An apparatus, comprising:
a light source;
illumination control means comprising an array of microelectromechanical systems (“MEMS”) devices; and
flash control means for controlling the light source and the illumination control means, the flash control means configured to control the illumination control means to form at least one transmissive area comprising a first plurality of adjacent MEMS devices and at least one non-transmissive area comprising a second plurality of adjacent MEMS devices.
